(19) United States
(12) Patent Application Publication
(10) Pub. No.: US 2006/0230154 A1
(43) Pub. Date: Oct. 12, 2006

(54) Method and entities for performing a push session in a communication system

(75) Inventors: Thinh Nguyenphu, Southlake, TX (US); Miguel-Angel Garcia-Martin, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/155,727

(22) Filed: Jun. 20, 2005

(30) Foreign Application Priority Data
Apr. 11, 2005 (EP) 05007881.5
Apr. 12, 2005 (EP) 05007942.5

(51) Int. Cl. G06F 15/16

(52) U.S. Cl. 709/227

(57) ABSTRACT

The present invention relates to an arrangement and method for performing a push operation in a communication system. Also, the present invention concerns an involved gateway entity and push destination entity. The arrangement comprises a receiver device, at a gateway entity of the communication system, configured to receive a request to perform a push operation towards a push destination entity, and comprises a connecting session device, at the gateway entity and the push destination entity. The connecting session device comprises setup means configured to setup a connecting session invoking a messaging session for delivering content to be pushed in the push operation towards the push destination entity.

### FIELD OF THE INVENTION

The present invention relates to communication systems. More particularly, the invention relates to a method and entities for performing a push session in a communication system.

### BACKGROUND OF THE INVENTION

A communication system can be seen as a facility that enables communication sessions between two or more entities such as one or more communication devices and/or other nodes associated with the communication system. A communication system typically operates in accordance with a given standard or specification setting out what the various entities associated with the communication system are permitted to do and how that should be achieved. A standard or specification may define a specific set of rules, such as communication protocols and/or parameters, on which connections between the entities can be based.

Wireless communication systems include various cellular or otherwise mobile communication systems using radio frequencies for sending voice or (non-voice) data between stations, for example between a communication device and a transceiver network element. Examples of wireless communication systems may comprise public land mobile network (PLMN), such as global system for mobile communication (GSM), the general packet radio service (GPRS) and the universal mobile telecommunications system (UMTS). A single communication system may interface with one or more other communication systems, such as with other wireless systems, such as a wireless Internet Protocol (IP) network, and/or fixed line communication systems.

Subscribers, such as the users or end-users, to a communication system may be offered and provided numerous services, such as calls, data communication or multimedia services or simply an access to a network, such as the Internet.

Servers may be used in provision of the services and may be operated by an operator of a network or by an external service provider. For example, a wireless application protocol (WAP) provides mobile communication devices services over wireless communication networks. Further examples of services may comprise, but are not limited to, short message service (SMS), multimedia messaging service (MMS), electronic mail (email), and so on.

A client of a communication device may request for a service or information from a server, which then responds in transmitting the requested service or information to the client. This may be referred to as a pull operation. An example of a pull operation may comprise a client allowing a user of a communication device to browse the Internet using a WAP or hypertext transfer protocol (HTTP) browser.

In an alternative, a server may transmit information or content without an explicit request from the client. This may be referred to as a push operation. Examples of push operation are discussed more in detail in the following.

A network operator or another party may (remotely) configure a communication device or provide the communication device with content or other information relating to a service. Examples of such information may comprise, but are not limited to, information relating to device management (DM). Further non-limiting examples of information may include news, stock quotes, weather, traffic reports and notification of events, such as email or MMS message arrival. Also, advertisements represent an example of such information desired to be and/or being pushed from a server to a client. For example in wireless communication systems, the information may be transmitted to the communication device over the air (OTA) interface.

The WAP Forum has defined a push OTA protocol for delivering content over the air from a push server to a communication device, such as a WAP enabled communication device. WAP Push Architectural Overview, Version 03-July 2001, Wireless Application Protocol, WAP-250-PushArchOverview-20010703-a, outlines the WAP push specifications, which together specify a service to push content to mobile devices via the WAP architecture.

In a push operation, a push initiator (PI) may transmit (in a push request) push content and delivery instructions to a push proxy gateway (PPG), which may then deliver the push content to a client in the communication device according to the delivery instructions. A push initiator and a push proxy gateway may be separate entities or co-located in a single entity. A push initiator may be an application desiring to push certain content or represent a co-located entity acting in response to a request to push content on behalf of such an application. A push request from a push initiator PI can be delivered directly or via one or more intermediary network nodes to the push proxy gateway PPG.

The push OTA is an application layer protocol that can be run on top of a wireless session protocol (WSP) for connectionless or connection-oriented push or on top of the HTTP protocol for connection-oriented push. The push OTA protocol may thus be referred to as OTA-WSP and OTA-HTTP, respectively. For initiating connectivity, the push proxy gateway PPG may send a request, such as a session initiation request (SIR), to a communication device to initiate connectivity. The request may be sent by connectionless push using the OTA-WSP, such as by means of an SMS. The communication device may then activate a bearer for a session as requested in the request and establish a session towards the PPG. The session may be a WSP or HTTP session or a transmission control protocol (TCP) connection. Details of Push OTA can be found in “Push OTA Protocol Specification”, WAP Forum™, WAP-235-PushOTA, to be retrieved via the OMA web site.

It might be desired to provide alternative ways to provide information or content to a communication device. In particular, it might be desired to provide alternative ways which might reduce signaling in the network and re-use existing protocols and already established connections.

In a previously proposed solution by the same applicant and at least partly the same inventors, a mechanism is suggested for providing, from a push server to a communication device, a new type of push protocol over a transport protocol for pushing information. This is described in FI patent application No. 20041634 filed on Dec. 20, 2004, for which also a corresponding US patent application has been filed.

According to the method proposed, a session invitation including a description of a push protocol over a transport protocol for establishing a push session is received; a transport bearer in accordance with said transport protocol is set up; and the transport bearer is used for the push session in accordance with said push protocol.

A somewhat similar approach is currently also under investigation by the Open Mobile Alliance, OMA, where it is investigated in using Session Initiation Protocol, SIP, to transport OMA PUSH content messages. In this case, SIP is just used as a transport protocol that carries the OMA PUSH content messages. These PUSH content messages can for example be, among others, MMS Notification, or Device Management messages. These messages are XML encoded messages that can be transported either with HTTP or WSP. One possible solution is to encapsulate the push content message into SIP messages (e.g., MESSAGE, NOTIFY, etc). For details, see for 3GPP2 MMS MMI SIP specification (3GPP2 X.S0016-312 Version 1.0 MMS MM1 Stage 3 Using SIP) to be retrieved via www.3GPP2.org web site.

However, the thus proposed methods still have to rely on routing the signaling via nodes of the core network of the communication system which nodes are involved in setting up the signaling channel.

Push services in general are distinguishable, for example, according to their type of push operation, as mentioned earlier above. These types of operations are sometime considered as “connectionless” and “connection-oriented”. For example, a “connectionless” type of Push service is a “low value” application, such as advertising. The push application wishes to communicate content to a user of a device, and does not require a receipt confirmation of delivery. In contrast thereto, a “connection-oriented” type of Push service is a “high value” application, such as a stock ticker. The application wishes to push content to a user. The application will use a push proxy, to initiate the communication of the content to the user's device. The push proxy initiating the pushing of the content is also referred to as push initiator PI. The content being communicated necessitates that the push proxy and mobile device may have to establish a common communication context such that confirmation of successful transport of the content is confirmed and subsequently notified back to the originator of the message, the application.

The OMA PUSH Service requires an operation, according to which the push service (the application pushing the content) may select to use a push operation with or without a receipt confirmation of delivery.

The OMA SIP PUSH technology is defining mechanisms to reuse the reachability functionality offered by SIP, to enable OMA PUSH operations to support push operations with and without confirmation of delivery, to be able to support a large amount of data being pushed from the proxy PPG to client device, to enable to push a variety of media types to the client and to detect client capability and preferences.

In relation to this, in still another previously proposed solution by the same applicant (presently unpublished FI patent application No. 20050149 filed on Feb. 9, 2005) and at least partly the same inventors, a mechanism is suggested for controlling push operations in association with capabilities information in a communication system, which are provided and made available for control of the push operation. However, this approach does not address the problems involved in a push operation as such and as outlined before.

Pushing of content to a terminal device according to the terminal's capabilities insofar involves a certain registration of the terminal at a push proxy gateway PPG.

According to the Push-OTA specification (“Push OTA Protocol Specification”, WAP Forum™, WAP-235-PushOTA), the term “registration” refers to a procedure where the Push Proxy Gateway (PPG) becomes aware of the device's current capabilities and preferences. The information is conveyed using headers, and may be stored in the PPG to avoid that the information is communicated in future transactions. During this registration procedure, the client and the PPG are also identified and optionally authenticated. The registration procedure is always initiated by the PPG.

Hence, as derivable from the above introduction into this technical area, various concepts are under investigation.

Some concepts rely on specifically designed application layer protocols which are operated on top of pre-existing protocol stacks. These, however, tend to increase the signaling involved. Others use transport layer protocols such as SIP, but thereby cause a risk of overloading SIP entities with tasks of push operations.

### SUMMARY OF THE INVENTION

Hence, it is an object of the present invention to further improve the above concepts and to remove inconveniences inherent to those previous concepts.

According to the present invention, this object is for example achieved by a method for performing a push operation in a communication system, the method comprising the steps of receiving, at a gateway entity of the communication system, a request to perform a push operation towards a push destination entity, and setting up a connecting session invoking a messaging session for delivering content to be pushed in the push operation towards the push destination entity.

Also, according to the present invention, this object is for example achieved by a method for performing a push operation in a communication system, the method comprising the steps of receiving, at a gateway entity of the communication system, a request to perform a push operation towards a push destination entity, and setting up a messaging session for delivering content to be pushed in the push operation towards the push destination entity.

According to favorable refinements of the above methods

said content to be pushed is received in said request to perform a push operation, and the method further comprises a step of delivering said content to said push destination entity using said messaging session;

said messaging session is invoked within the context of the connecting session;

said messaging session is a Message Session Relay Protocol, MSRP, session and the connecting session is a Session Initiation Protocol, SIP, session;

said content to be pushed is encapsulated in at least one MSRP request;

said delivering step comprises a step of configuring said messaging session by setting at least one messaging session parameter to report success of the push operation;

the method further comprises a step of reporting, from the push destination entity towards the gateway entity, success of the push operation in a report message of the messaging session;

the method further comprises a step of converting, at the gateway entity, the report message of the messaging session into a push result message for further transmission responsive to the request received in the receiving step;

said receiving step further comprises a step of analyzing the received request to perform a push operation, wherein said analyzing comprises at least whether the request to perform a push operation requests a connection oriented push operation for which a report of success is required, and said delivering step is configured responsive to said analyzing.

According to the present invention, this object is for example achieved by an arrangement for performing a push operation in a communication system, the arrangement comprising a receiver device, at a gateway entity of the communication system, configured to receive a request to perform a push operation towards a push destination entity, and connecting session device, at the gateway entity and the push destination entity, the connecting session device comprising setup means configured to set up a connecting session invoking a messaging session for delivering content to be pushed in the push operation towards the push destination entity.

According to favorable refinements of the arrangement

said content to be pushed is received at said receiver device in said request to perform a push operation, and the connecting session device comprises a messaging session device comprising a delivering means configured, at said gateway entity, to deliver said content to said push destination entity using said messaging session, and configured, at said push destination entity, to pickup said delivered pushed content;

said setup means of said connecting session device is configured to invoke the messaging session in the context of the connecting session;

said messaging session device is configured to conform to a Message Session Relay Protocol, MSRP, and the connecting session conforms to a Session Initiation Protocol, SIP, session;

the messaging session device is configured to encapsulate said content to be pushed in at least one MSRP request;

said delivering means comprises a configuration element configured to configure said messaging session by setting at least one messaging session parameter to report success of the push operation;

said delivering means, at the push destination entity, further comprises a reporting element, push destination entity, configured to report, from the push destination entity (UA) towards the gateway entity (PPG), success of the push operation in a report message of the messaging session, and wherein said delivering means, at the gateway entity, is configured to pickup said report message.

the arrangement further comprises a converter means, at the gateway entity, configured to convert the report message of the messaging session, into a push result message for further transmission;

said receiver device further comprises an analyzer configured to analyze the received request to perform a push operation, wherein said analyzing comprises at least whether the request to perform a push operation requests a connection oriented push operation for which a report of success is required, and said analyzer outputs a control signal supplied to a configuration element, which is configured to configure said delivering means of the messaging session device dependent on the control signal.

According to the present invention, this object is for example achieved by a gateway entity for use in performing a push operation in a communication system, the gateway entity comprising a receiver device configured to receive a request to perform a push operation towards a push destination entity and a connecting session device comprising setup means configured to set up a connecting session invoking a messaging session for delivering content to be pushed in the push operation towards the push destination entity.

According to favorable refinements of the gateway entity

said content to be pushed is received at said receiver device in said request to perform a push operation, and the messaging session device further comprises a delivering means configured to deliver said content to said push destination entity using said messaging session;

said setup means of said connecting session device is configured to invoke the messaging session in the context of the connecting session;

said messaging session device is configured to conform to a Message Session Relay Protocol, MSRP, and the connecting session conforms to a Session Initiation Protocol, SIP, session;

said messaging session device is configured to encapsulate said content to be pushed in at least one MSRP request;

said delivering means comprises a configuration element configured to configure said messaging session by setting at least one messaging session parameter to report success of the push operation;

the gateway entity further comprises a converter means, configured to convert a report message of the messaging session into a push result message for further transmission;

said receiver device further comprises an analyzer configured to analyze the received request to perform a push operation, wherein said analyzing comprises at least whether the request to perform a push operation requests a connection oriented push operation for which a report of success is required, and said analyzer outputs a control signal supplied to a configuration element, which is configured to configure said delivering means of the messaging session device dependent on the control signal.

According to the present invention, this object is for example achieved by a push destination entity for use in performing a push operation in a communication system, the push destination entity comprising a connecting session device comprising setup means configured to set up a connecting session invoking a messaging session for receiving content delivered in the push operation from a gateway entity of the communication system.

According to favorable refinements of the push destination entity

said messaging session device comprises a delivering means configured as a receiving means to pickup content pushed from a gateway entity;

said setup means of said connecting session device is configured to invoke the messaging session in the context of the connecting session;

said messaging session device is configured to conform to a Message Session Relay Protocol, MSRP, and the connecting session conforms to a Session Initiation Protocol, SIP, session;

said messaging session device is configured to receive pushed content encapsulated in at least one MSRP request;

said configuration element is configured to detect at least one set messaging session parameter set to define a request to report success of the push operation;

said delivering means further comprises a reporting element, responsive to said configuration element and configured to report, from the push destination entity towards the gateway entity, success of the push operation in a report message of the messaging session.

Still further, according to the present invention the above object is achieved, for example, by a computer program product comprising software code portions and performing the method steps as set out under any aspect above when the respective software code portions are executed on a respective computer processor at a gateway entity and a push destination entity.

Thus, as will become apparent, the present invention will lead to at least the following advantages being achieved, compared to pre-existing solutions:

The solution preserves the OMA PUSH concept.

Thus, it offers backward compatibility with the pre-existing system and push applications at clients and servers.

The solution is transparent to the user and has hardly any impact to the terminal (push destination entity) application implementation.

The solution simplifies the procedures of registration and inquiry of terminal capabilities.

This solution does not have a size restriction for push messages.

This solution does not traverse the SIP/IMS core; hence it does not impose any (additional) load on SIP proxies due to provisioning of push proxies.

Thus, this solution has no impact to the CSCF performance as a SIP proxy.

### BRIEF DESCRIPTION OF THE DRAWINGS

The present invention will be described herein below with reference to the accompanying drawings, in which

FIG. 1 shows in outline an arrangement for performing a push operation in a communication system, and in particular the signaling involved according to the method according to the present invention;

FIG. 2 shows as a block circuit diagram a gateway entity for use in performing a push operation in a communication system according to the present invention; and

FIG. 3 shows as a block circuit diagram a push destination entity according to the present invention.

### DETAILED DESCRIPTION OF THE EMBODIMENTS OF THE INVENTION

The present invention will be described herein below in detail with reference to the accompanying drawings.

For the purpose of the present invention to be described herein below, it should beforehand be noted that

a communication device may for example be any device by means of which a user may access a communication system, or which may be accessed by a communication system in e.g. a push operation; this implies mobile as well as non-mobile devices and network systems, independent of the technology platform on which they are based; only as an example, it is noted that e.g. terminals operated according to principles standardized by the 3^{rd} Generation Partnership Project 3GPP and known for example as UMTS terminals are particularly suitable for being used in connection with the present invention;

“content” as used in the present application in terms of content to be pushed is intended to mean at least one of audio data, video data, image data, text data, and meta data descriptive of attributes of the audio, video, image and/or text data, any combination thereof or even, alternatively or additionally, other data such as, as a further example, program code of an application program to be accessed/downloaded or control data for device management purposes; content may comprise further data of any Multipart Internet Mail Extension, MIME, type;

method steps likely to be implemented as software code portions and being run using a respective processor at one of the entities involved are software code independent and can be specified using any known or future developed programming language;

method steps and/or devices likely to be implemented as hardware components at one of the entities are hardware independent and can be implemented using any known or future developed hardware technology or any hybrids of these, such as MOS, CMOS, BiCMOS, ECL, TTL, etc, using for example ASIC components or DSP components, as an example;

generally, any method step is suitable to be implemented as software or by hardware without changing the idea of the present invention;

devices can be implemented as individual devices, but this does not exclude that they are implemented in a distributed fashion throughout the system, as long as the functionality of the device is preserved.

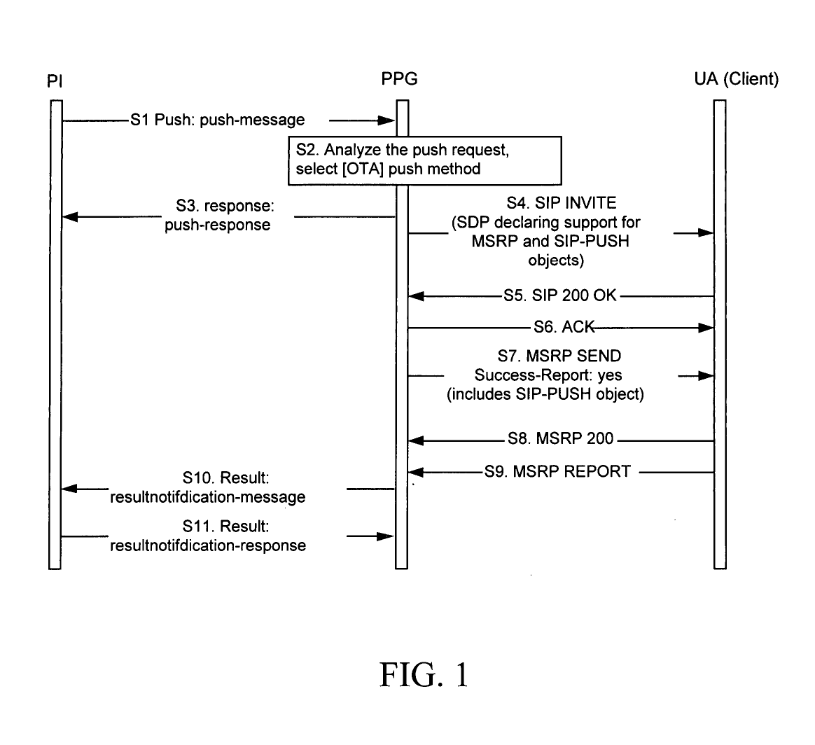

FIG. 1 shows in outline an arrangement for performing a push operation in a communication system, and in particular the signaling involved according to the method according to the present invention.

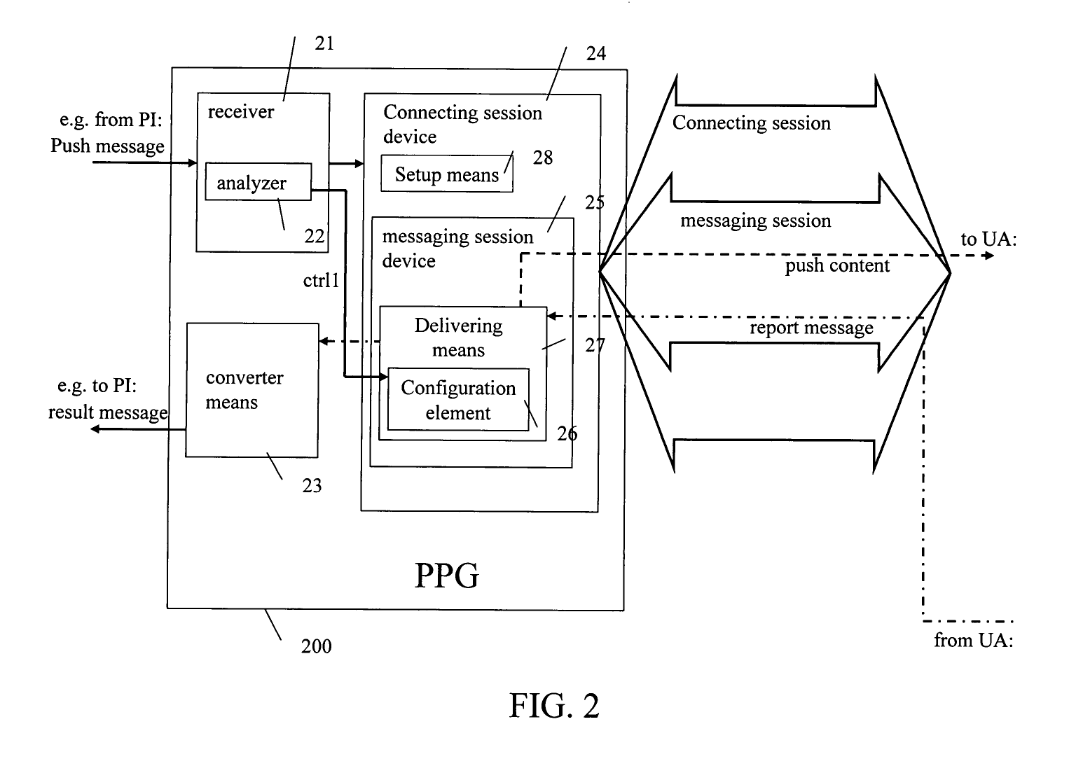

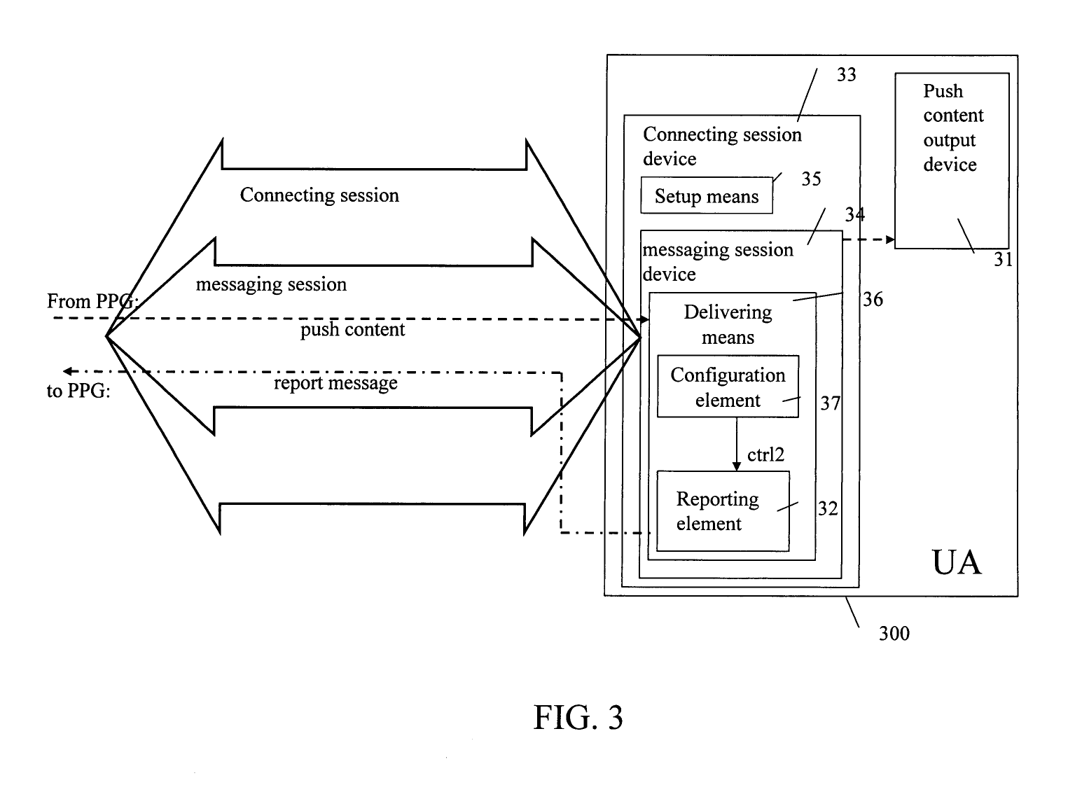

The arrangement is represented without illustrating internal details on the structure of entities involved. Details related to the structure of entities and/or devices are given in FIGS. 2 and 3 insofar as they are related to the present invention. In FIG. 1, in horizontal direction, the entities are illustrated together with the respective signaling exchanged between them; in vertical direction, the sequence of signaling messages is illustrated. The sequence in time is also reflected by the numbering in the steps S1 to S11 denoting the respective signaling messages.

A push initiator entity PI denotes a push operation requesting entity. This can be co-located to e.g. an application server entity desiring to push a certain content, or receive respective trigger/control signals from a remotely located application entity. For the purpose of the present invention, any such distinction is not considered further. Rather, the push initiator is considered to be the source requesting to perform a push operation. The push request can be forwarded directly from the push initiator or via one or more intermediary nodes (not shown) to a push proxy gateway PPG.

A push proxy gateway PPG denotes a gateway entity involved in forwarding and/or relaying the content to be pushed via a communication system, of which the gateway forms a part of, towards a push destination entity.

A push destination entity is represented as a user agent UA and/or a client. Such a user agent and/or client can reside in an application run on a terminal of a user. For the purpose of the present invention, such a user agent is considered without a focus on the technical implementation of the terminal as such, i.e. whether the terminal is a fixed or wireless terminal and to which standard specification the terminal conforms (e.g. GPRS or UMTS).

The subsequent description focuses on a specific embodiment which was considered by the present inventors to be a particularly enabled working embodiment and could thus be considered as a currently known “best mode” for practicing the present invention. The description of the specific embodiment, however, is not intended to exclude alternative implementations which may rely on different protocols not mentioned, but which preserve the functionality of and the advantages achieved by using the mentioned ones.

Between the push proxy gateway PPG and the push initiator PI there is an interface conforming to the PAP protocol (see appendix, reference [PushPAP] for details). The PAP protocol sets out specific operations, which the push proxy gateway PPG follows in order to deliver the push content to the user's terminal.

Between the push proxy gateway PPG and the push destination entity UA there is an interface conforming to an Over The Air, OTA, protocol, controlling usage of a bearer between the push proxy gateway entity PPG and the push destination entity UA

The following paragraphs give an overview of the push proxy gateway PPG operations in conjunction with the corresponding operations of the push destination entity UA and other entities of the arrangement.

For details of operations of the gateway PPG and the message formats used, such as field definitions, reference is made to the reference [PPGService] listed in the appendix. They are not discussed here in too great detail since the present invention focuses on another aspect.

PPG Push Submission Processing Overview:

The purpose of the Push Submission is to deliver or to replace a push message from a Push Initiator PI to a push proxy gateway PPG. The push proxy gateway PPG should then deliver the push message to a user agent UA (client) as a push destination entity in a user's terminal device associated to the communication system such as a wireless network.

The Push message is sent in step S1 from the push initiator PI to the push proxy gateway PPG as a push request.

The push request message contains a control entity and a content entity, and may contain a capabilities entity. An entity of a message is denoting a part or block of the message.

The control entity is e.g. an XML document (extended Markup Language) that contains control information (within the push-message)—(for details refer to reference [PushPAP] listed in the appendix)—for the push proxy gateway PPG to use in processing the message for delivery.

The content entity represents content to be sent to the push destination entity UA such as e.g. a wireless device.

The capabilities entity contains client capabilities assumed by the Push Initiator and is e.g. in the RDF format—(for details refer to reference [RDF] listed in the appendix)—as defined in the User Agent Profile—(for details refer to reference [UAPROF] listed in the appendix).

The PPG may use the capabilities information to validate that the message is appropriate for the client. This means, that the push proxy gateway may be configured to filter inappropriate push messages and to thereby prevent their delivery based on capabilities information. Capabilities information may for example reside in indicating that a terminal (push destination entity) is multimedia enabled or not. Such processing is preferred in terms of avoiding the pushing of inappropriate push messages to a terminal's client. Nevertheless, optionally a push proxy gateway may also unconditionally deliver push messages.

Push submission processing includes four operations. The following three operations are performed in this order:

Push Submission Acceptance or Rejection:

Each PAP push submission (i.e. push request message) received upon step S1 by the push proxy gateway PPG is either accepted or rejected. Acceptance or rejection is the result of the analysis performed by the push proxy gateway in step S2.

The gateway PPG should accept a PAP push submission if it might ultimately be delivered to the push destination entity such as an OTA client in this example of a wireless communication system.

The PPG must, however, reject any push submission (push message) containing a PAP push-message element that is not valid with respect to its document type definition (DTD). For example, in case a push message content entity does not conform to the capabilities of the push destination entity, the push message is prevented from being pushed.

In case of acceptance, the push method is determined based on information contained in e.g. the push request's control entity.

The analyzing comprises at least to analyze whether the request to perform a push operation requests a connection oriented push operation for which a report of success is required, and if so, pushing/delivering is configured accordingly responsive to said analyzing.

The result of analyzing is informed from the gateway PPG in step S3 as a push response to the push initiator PI.

If the message is accepted and can be delivered in accordance with PPG policies and PI requirements, over-the-air message delivery takes place.

Over-the-Air Message Transmission:

This functionality delivers messages to the OTA client (user agent UA/client at a terminal) as a push destination entity. This functionality comprises selection and/or activation of a determined Push OTA (see reference [PushOTA] listed in appendix for details) protocol (e.g. based on determination/analysis in step S2), selection of confirmed or unconfirmed push mode, push message delivery, and network bearer selection. Above mentioned selection steps are illustrated as forming part of step S2 illustrated in FIG. 1.

The push proxy gateway PPG sends a PAP result response to the PI in step S3, as mentioned above.

Further, in step S4, the push proxy gateway PPG sends an SIP INVITE request to the push destination entity UA. SIP, Session Initiation Protocol is used as an example only; in connection with the present invention, a non-SIP session could be setup using a different session setup or rendezvous protocol. The SIP INVITE contains a session description protocol SDP entity describing (e.g. properties of) an MSRP media stream and declaring support for a number of MIME types that are applicable (e.g., this could be a generic OMA SIP PUSH MIME type or a specific one, such as Device Management DM). Thus, stated in other words, there occurs a setting up of a connecting session (here: SIP (with SDP)) which invokes a messaging session (here MSRP) for delivering content to be pushed in the push operation towards the push destination entity (UA).

The client UA accepts the session by returning in step S5 a SIP 200 OK message.

The push proxy gateway PPG in turn acknowledges the reception of the SIP 200 OK in a step S6 (“ACK”).

Thereafter, in step S7, the push proxy gateway PPG sends a request to push content using Message Session Relay Protocol MSRP with SIP. The request is represent by a so-called object to be pushed over the air interface using e.g. SIP as a connecting session. This means: the MSRP SEND request contains a special MIME type in the Content-Type header, different of text/plain or text/html. For example, it could be application/oma-sip-push+xml. Such MIME type is an example of an above mentioned object: an encapsulation in SIP protocols of the push XML document.” The push proxy gateway PPG, in step S7, encapsulates such object in the MSRP SEND message (encapsulating is done in at least one MSRP send message). It also configures the messaging session by setting the MSRP header Report-Success to “yes” in order to request confirmation of delivery. (Such setting can be configured fixedly for all push messages or dependent on the analysis in step S2, e.g. dependent on PUSH type or PUSH content type (e.g. MIME type)). For example, the PUSH type “connection-oriented” involving receipt of successful delivery may overrule other criteria and trigger the above mentioned header setting. On the other hand, in case of one or more specific MIME types, the header setting could be triggered even in case of a PUSH type “connectionless”.

The control entity of the push message is a MIME body part, which holds e.g. an XML document containing one PAP element as defined in reference [PushPAP]. For example, the push-message element carries the quality-of-service attribute, which gives the push proxy gateway PPG specific instructions for delivery of the message. The QoS attribute is translated into over-the-air SIP protocol operation methods.

The actual content to be pushed is delivered step S7. The MSRP SEND request includes the object/content to be pushed. Also, more than one MSRP SEND request carrying the content can be sent. For example, large push contents can be split and pushed in consecutive MSRP SEND messages. This involves using the MSRP feature named “message-chunking enabled”. In any case, the object (content) to be pushed is encapsulated in at least one such MSRP SEND request.

The client UA sends an MSRP 200 response in step S8. This cannot be used as a confirmation of delivery, because if it had been an MSRP relay in between the gateway PPG and the UA, the MSRP 200 response would have been generated by the MSRP relay rather than by the UE.

Therefore, based on the MSRP messaging session established, the client UA sends in a subsequent step S9 an MSRP REPORT message to the gateway PPG. This constitutes the confirmation of delivery of the sent MSRP message containing the pushed PUSH object.

Optionally, the gateway PPG converts the success report and sends a corresponding delivery result notification message, step S10, if the message is accepted and the push initiator PI requested message delivery notification. The “resultnotification-response” is sent in step S11 by the Push Initiator PI to confirm receipt of the “resultnotification-message” of step S10.

As has become apparent from the preceding description of the arrangement and the signaling involved, the present invention concerns a method for performing a push operation in a communication system. The method basically comprises the steps of receiving, S1, at a gateway entity PPG of the communication system, a request to perform a push operation towards a push destination entity UA. Further, the method involves setting up, S4, a connecting session invoking a messaging session for delivering content to be pushed in the push operation towards the push destination entity UA. Said content to be pushed is received in said request S1 to perform a push operation (together with control information for the push operation). The method further comprises a step of delivering, S7, said content to said push destination entity UA using said messaging session. The messaging session is invoked within the context of the connecting session. The messaging session is a Message Session Relay Protocol, MSRP, session and the connecting session is a Session Initiation Protocol, SIP, session.

Any content to be pushed is encapsulated in at least one MSRP request. The delivering step comprises configuring said messaging session by setting at least one messaging session parameter to report success of the push operation. The receiving step further comprises a step of analyzing, S2, the received request to perform a push operation, and said delivering step, S7, is configured responsive to said analyzing. The analyzing comprises at least to analyze whether the request to perform a push operation requests a connection oriented push operation for which a report of success is required. The method further comprises a step of reporting, S9, from the push destination entity UA towards the gateway entity (PPG), success of the push operation in a report message of the messaging session. Additionally, the method may further comprise a step of converting, at the gateway entity PPG, the report message of the messaging session into a push result message for further transmission, S10, responsive to the request received in the receiving step S1.

Hereinbefore, the arrangement was described with a focus on the involved signaling. It will, however, be understood that the arrangement for performing a push operation in a communication system therefore comprises a receiver device, at a gateway entity PPG of the communication system, which is configured to receive a request to perform a push operation towards a push destination entity UA, and a connecting session device, at the gateway entity and the push destination entity. The connecting session device comprises setup means configured to set up a connecting session invoking a messaging session for delivering content to be pushed in the push operation towards the push destination entity UA.

A setup means at the gateway entity may request setup of a connecting session invoking a messaging session and a setup means at the push destination entity may accept such request. Both setup means therefore cooperate in setting up a messaging session.

The setup means of said connecting session device is configured to setup the connecting session invoking the messaging session in the context of the connecting session. This applies for the gateway entity as well as for the destination entity. The messaging session device is configured to conform to a Message Session Relay Protocol, MSRP, and the connecting session conforms to a Session Initiation Protocol, SIP, session.

The content to be pushed is received at said receiver device in said request to perform a push operation. The messaging session device further comprises a delivering means configured, at said gateway entity, to deliver said content to said push destination entity UA using said messaging session, and configured, at said push destination entity, to pickup said delivered pushed content.

This means that delivered (pushed) content is received at the destination entity.

The delivering means comprises a configuration element configured to configure said messaging session by setting at least one messaging session parameter to report success of the push operation. The configuration element at the gateway entity may request/initiate configuration of a messaging session and the configuration element at the push destination entity may accept such request. Both configuration elements therefore cooperate in configuring a messaging session. The receiver device further comprises an analyzer configured to analyze the received request to perform a push operation. The analyzer analyzes at least whether the request to perform a push operation requests a connection oriented push operation for which a report of success is required. The analyzer outputs a control signal supplied to said configuration element, which is configured to configure said delivering means of the messaging session device dependent on the control signal.

The delivering means, at the push destination entity, further comprises a reporting element, configured to report, from the push destination entity UA towards the gateway entity PPG, success of the push operation in a report message of the messaging session; and the delivering means, at the gateway entity, is configured to pickup said report message, i.e. a delivered report message is received at the push gateway entity.

The arrangement further comprises a converter means, at the gateway entity, configured to convert the report message of the messaging session, into a push result message for further transmission. The further transmission can be directed to the push initiator PI, if requested in the push request message, directly or via one or more intermediary nodes.

Note that the gateway entity as well as the push destination entity are described as comprising a delivering means. This is intended to mean that the gateway entity's delivering means delivers/sends pushed content to the destination device's delivering means; while the destination entity's delivering means is configured to receive (pickup) such pushed content. Likewise, a report message is delivered/sent from the destination entity's delivering means (reporting element) to the gateway entity's delivering means; the gateway entity's delivering means is thus configured to receive (pickup) such report message.

As regards details of the entities involved in implementing the present invention, these are shown in the block circuit diagrams of FIGS. 2 and 3, respectively.

FIG. 2 shows those elements and/or parts of a push proxy gateway entity related to the present invention. The gateway entity is part of the above described arrangement and configured to conform to the method disclosed further above. Other constituents of a push proxy gateway not directly related to the present invention are omitted from the illustration.

The gateway entity PPG is configured for use in performing a push operation in a communication system. The gateway entity PPG comprises in relation to the present invention a receiver device 21 configured to receive a request to perform a push operation. The request is received from a push operation requesting entity (e.g. an application) or push initiator PI. The request is received either directly or via one or more intermediary nodes. The request is internally processed in the receiver device 21 (in an analyzer 22 to be described later) and passed to a connecting session device 24 configured to set up a connecting session for a connection from the gateway entity PPG towards a push destination entity UA of the communication system, i.e. between these entities. The connecting session device 24 is merely illustrated to comprise a setup means 28 configured to setup a connecting session invoking a messaging session. The messaging session is handled by a messaging session device 25 configured to establish a messaging session within the context of the connecting session, for delivering content to be pushed in the push operation towards the push destination entity UA. The connecting session device need not actually comprise the messaging session device, as long as the devices cooperate with each other to realize the functionality involved by the present invention.

The messaging session device 25 comprises a delivering means 27. The delivering means 27 comprises a configuration element 26 configured to configure said messaging session by setting at least one messaging session parameter to report success of the push operation.

The gateway entity PPG further comprises a converter means 23 configured to convert a report of success message of the messaging session (received from the push destination device) into a result message for further transmission from the push proxy gateway entity PPG towards the push operation requesting entity, e.g. PI, either directly or via one or more intermediary nodes.

The receiver device 21 further comprises, for internal processing purposes mentioned above, an analyzer 22 configured to analyze the received request to perform a push operation. The analyzer 22 outputs a control signal ctrl1 supplied to the messaging session device 25 at said gateway entity, more precisely to the configuration element 26 thereof. Dependent on the control signal said messaging session device 25 configures said messaging session by setting at least one messaging session parameter to report success of the push operation. Configuring is realized by the configuration element 26. The configuration element 26 may optionally configure the messaging session independent of the control signal so as to report success of the push operation. Criteria for analysis and configuration are as described above in relation to the method aspect and therefore not repeated here. The push content as well as the report message are carried within the messaging session invoked and/or established in the context of the connecting session, as illustrated in FIG. 2, to and from the push destination entity UA. The push message (request) is received e.g. from the push initiator PI and the result message (converted report message) is transmitted to e.g. the push initiator PI. In a particular suitable embodiment described here, the messaging session device is configured to conform to a Message Session Relay Protocol, MSRP, and the connecting session conforms to a Session Initiation Protocol, SIP, session.

FIG. 3 shows those elements and/or parts of a push destination entity UA related to the present invention. This entity is also part of the above described arrangement and configured to conform to the method disclosed further above. Other constituents of the push destination entity UA not directly related to the present invention are omitted from the illustration.

The push destination entity UA is configured for use in performing a push operation in a communication system. The push destination entity UA comprises a connecting session device 33 comprising setup means 35 configured to set up a connecting session invoking a messaging session for receiving content delivered in the push operation from a gateway entity of the communication system, i.e. the connecting/messaging sessions are between these entities. The connecting session device 33 is illustrated as further comprising a messaging session device 34 handling the messaging session invoked within the context of the connecting session for delivering content to be pushed in the push operation towards the push destination entity UA. The connecting session device need not actually comprise the messaging session device, as long as the devices cooperate with each other to realize the functionality involved by the present invention.

The messaging session device 34 comprises a delivering means 36 which comprises a configuration element 37 configured to configure said messaging session by setting at least one messaging session parameter to report success of the push operation.

Note that as mentioned above, the setup means at the gateway entity may request setup of a connecting session invoking a messaging session and the setup means at the push destination entity may accept such request. Both setup means therefore cooperate in setting up a connecting session invoking a messaging session. The setup means of said connecting session device is configured to invoke the messaging session in the context of the connecting session. This applies for the gateway entity as well as for the destination entity. The messaging session device is configured to conform to a Message Session Relay Protocol, MSRP, and the connecting session conforms to a Session Initiation Protocol, SIP, session.

The push destination entity UA further comprises a reporting element 32 (associated to the delivering means 36) configured to report, from the push destination entity UA towards the gateway entity PPG, success of the push operation in a report message. The reporting element 32 is controlled by a signal ctrl2 supplied thereto from the configuration element 37 of the delivering means 36 of the messaging session device 34.

Furthermore, pushed content received at the push destination device UA is passed internally (via the messaging session device/connecting session device) to a push content output device 31. This can be any appropriate memory and/or output device such as a display or loudspeaker enabling an end-user of the device/terminal to perceive the pushed content (i.e. reading or hearing it, dependent on the type of content pushed). Note that, however, if the content is for example terminal configuration data or settings (e.g. device management data mentioned above), then the content is not intended to end users but to terminal internal purposes; such content is rather passed to a memory and used for changing device settings maintained at that or another memory or memory partition. Generally, pushed content is delivered to the respective application to which the pushed content refers and/or belongs.

As will be appreciated from the foregoing, basically, with the present invention being implemented, the usage of the SIP, and other IETF protocols usable as protocol on the basis of which a connecting session is enabled, is maximized to support the concept of “connectionless” and “connection-oriented” of type push. These types of push can be mapped into the IETF Instant Messaging concept of Page and Session mode, as follow:

| OMA PUSH Concept | IETF IM Concept |
|---|---|
| “connectionless” | Page Mode |
| (No Confirmation of Delivery) | |
| “connection-oriented” | Session Mode |
| (Confirmation of Delivery) | |

This invention addresses the connection-oriented type of push operations, where a push proxy gateway entity PPG

establishes some kind of session;

is aware of the terminal's (push destination entity's) capabilities;

uses user plane to push large amount of content data to deliver them to the push destination entity,

does not traverse the SIP/IMS core network; and

requests and receives delivery confirmation.

To resolve the above challenges in relation to session establishment and terminal capabilities awareness, the push proxy gateway PPG uses in a particular embodiment the Message Session Relay Protocol (MSRP) [IETF-MSRP] with SIP [RFC3261]. The MSRP sessions will typically be initiated using the session Description Protocol (SDP) via the SIP offer-answer mechanism [RFC3264]. The push proxy gateway entity PPG and the push destination entity such as a user agent UA of a user equipment UE (generally, a terminal) negotiate the supported content types such as MIME types in an “a=accept-types: MIME-type” declared in the SDP (as it is described in MSRP [IETF-MSRP])

Once the SIP session as an example of a connecting session is setup/established and the MSRP session as an example of a messaging session is invoked and established, the push proxy gateway PPG sends one or more MSRP SEND requests (see step S7 in FIG. 1) that contains PUSH objects identified with a particular MIME type. Typically this MIME type will be different on a per PUSH application, so that a Device Management application pushing content may use a different MIME type content than an MMS application pushing content.

To support large push content data in the user plane, the push proxy gateway PPG may use the MSRP SEND request with the message-chunking enabled.

To support delivery confirmation, i.e. a report on the success of delivered pushed contents, the push proxy gateway PPG uses MSRP Transaction and Report model, where a configuration is set to the Report-Success=yes.

Such setting can be fixed for all push contents or configured dependent on a push message (e.g. push application type, pushed content type, or other criteria)

MSRP—see for details reference [IETF-MSRP] in the appendix is chosen as an example for the purpose of describing the present invention only, however, any other suitable text-based, connection-oriented protocol for exchanging arbitrary content such as MIME content could be chosen within the framework of the present invention, as long as it preserves the MSRP functionalities exploited/relied on in connection with the present invention. The MSRP sessions are typically arranged using SIP the same way a session of audio or video media is setup. In addition, MSRP offers the capability of message chunking, where the push messages are divided up into smaller size to be transported to the client device (push destination entity). Also, MSRP provides the transaction and report mechanism.

MSRP is a text-based, connection-oriented protocol for exchanging arbitrary (binary) MIME content, especially instant messages. MSRP works and is used with SIP.

MSRP sessions are typically arranged using SIP the same way a session of audio or video media is setup. One SIP user agent (PPG) sends to the other (UA) a SIP invitation containing an offered session-description which includes a session of MSRP. The receiving SIP user agent can accept the invitation and include an answer session-description which acknowledges the choice of media. The PPG's session description contains an MSRP URL that describes where the PPG is willing to receive MSRP requests from the UA, and vice-versa. MSRP defines two request types, or methods. SEND requests are used to deliver a complete message or a chunk (a portion of a complete message), while REPORT requests report on the status of an earlier SEND request. When the PPG receives the UA's answer, the PPG checks to see if it has an existing connection to the UA. If not, PPG opens a new connection to the UA using the URL the UA provided in the SDP. The PPG then delivers a SEND request to the UA with its initial message, and the UA replies indicating that the PPG's request was received successfully.

Note that there are two sessions in this invention: one e.g. in SIP signaling as a connecting session; the other is MSRP session as a messaging session. The connecting session has the purpose of invoking and/or establishing the messaging session, while the messaging session alone would be insufficient, as it always needs a signaling (connecting) session.

As regards the respective session's protocol stacks:

MSRP and SIP are independent, i.e. the packets forwarded under SIP don't follow the same path as the MSRP packets. MSRP follows the user plane, whereas SIP follows the signaling plane, and traditionally these two planes follow separate paths. MSRP is comparable, from the user plane point of view, to RTP. RTP requires SIP/SDP to establish the session, and so does MSRP. MSRP, unlike RTP, is text based (looks like SIP sometimes), and MSRP relays are located in the user plane path (unlike RTP that is end-to-end oriented). So the SIP stack is SIP(SDP)/UDP or SIP(SDP)/TCP. The brackets in SDP indicate “piggybacked in SIP”. The MSRP stack is “just” MSRP/TCP. (Similarly (although not applicable to this invention), the RTP stack would look like RTP/UDP.) There is always a connection setup (SIP) which defines/invokes MSRP resources (URL) to be used; however, these MSRP resources as such could already exist. SIP is usually on top of UDP. MSRP is on top of TCP. It does not matter if the transport layer is different since there are two different sessions. SIP requests and MSRP messages do not follow the same path. SIP requests are routed via SIP proxies, however MSRP messages are routed via some kind of MSRP relay elements. To summarize: SIP includes SDP body which contains MSRP details for invoking MSRP messaging session, and the purpose of MSRP details is to invoke MSRP session between UE and PPG.

Both, the gateway PPG and the destination device UA comprise the connecting session device and the messaging session device including delivering means and configuration element. The respective means cooperate in a handshake procedure such that a request issued by e.g. the PPG is processed/accepted at the UA and/or vice versa. The processing performed at the gateway side is therefore to a certain extent to be regarded as being complementary to those performed at the destination device side.

Also, the device, means and elements forming part of the gateway and/or the destination entity can be implemented in hardware or software. When implemented in software, the block circuit diagram represent software modules of a computer program product. The gateway as well as the destination device then comprise a respective computer processor. Hence, it is to be understood that the present invention, though not described in terms of specific software code, also relates to a computer program product comprising software code portions and performing the method steps as set out under any aspect of the preceding method description, when the respective software code portions are executed on a respective computer processor at a gateway entity and a push destination entity.

Accordingly, as has been described herein before, the present invention relates to an arrangement and method for performing a push operation in a communication system. Also, the present invention concerns an involved gateway entity and push destination entity. The arrangement comprises a receiver device, at a gateway entity of the communication system, configured to receive a request to perform a push operation towards a push destination entity, and comprises a connecting session device, at the gateway entity and the push destination entity. The connecting session device comprises setup means configured to setup a connecting session invoking a messaging session for delivering content to be pushed in the push operation towards the push destination entity.

It is noted that the present invention herein before has been described using a high level description, which is nevertheless considered to be understood by those skilled in the art. Hence, it is more or less self-understood that the PPG, or another push gateway or push entity, may implement network access-control policies about who is able to gain access to the network, that is, who is able to push content and who is not, under which circumstances, and so on. The PI and the PPG 200 may communicate between each other using a push access protocol (PAP) as summarized in the document WAP-250-PushArchOverview-20010703-a. The PAP supports push submission, result notification, push cancellation, push replacement, status query and client capabilities query. In push submission, a message comprising a control entity, a content entity and optionally a capability entity is sent from the PI 24 to the PPG 22. The control entity contains the delivery instructions for the PPG 22. The control entity may be an extensible markup language (XML) document. The PI, or another push server, may be a separate network entity or a single network entity with the push entity, such as with the PPG 200. In embodiments of the invention, the push server may be provided in a device management server, in a multimedia messaging service center (MMSC) or in another appropriate network entity. It shall be appreciated that the Figures are only an example showing only one communication system in connection with one communication device (push destination entity UA), one push proxy gateway PPG together with one push initiator (application server). The number and type of entities concerned in a communication system may differ substantially from that which is shown. The communication networks typically further comprise various switching and other control entities and gateways for enabling the communication for interfacing a single communication network with one or more communication networks. In order to enhance clarity, these control entities are not shown in the Figures. A communication system is typically arranged to serve a plurality of communication devices. Furthermore, a communication device may have several simultaneous communication sessions, for example a number of session initiation protocol (SIP) sessions and activated packet data protocol (PDP) contexts. Communication devices may be connected to the communication system from the same or different networks. Communication devices may access the communication system via any appropriate access system. Examples may include, but are not limited to, radio access networks, e.g. an UMTS terrestrial radio access network (UTRAN) or a GSM/EDGE radio access network (GERAN), and short-range wireless systems, such as the Bluetooth, different types of fixed access systems, and so on. A mobile communication system may logically be divided into a radio access network (RAN) and a core network (CN). The communication device UA may access the communication network 10 via an access entity (not shown) of the RAN. The communication device 12 may, for example, wirelessly transmit and receive radio signals via a radio interface to and from a transceiver network element connected to the access entity. Correspondingly, the transceiver network element may wirelessly transmit and receive radio signals to and from the first communication device UA. Services over wireless communication networks may use capabilities of, for example, the Internet Protocol multimedia (IM) core network subsystem (IMS). The IMS enables IP connections for a communication device and other parties to the communication, such as other communication devices or entities associated with the network. The third generation partnership project (3GPP) has defined use of the GPRS for offering IP connectivity to IMS services. The 3GPP has further defined a call control protocol for use in the IMS based on a session initiation protocol (SIP) and an associated session description protocol (SDP). In an embodiment, the communication system is a SIP controlled system/network. Further, in an embodiment, the communication network is provided at least in part by the IMS. In the IMS, SIP based connection control is handled by SIP proxies called Call State Control Functions (CSCFs, not shown in the figure). Another appropriate SIP controlled communication system may be used as well. In a 3GPP network, a packet data session is established to carry traffic flows over the network. Such a packet data session is often referred to as a packet data protocol (PDP) context. A PDP context may include a radio bearer provided between a communication device and a radio network controller, a radio access bearer provided between the communication device UA, the radio network controller and a serving GPRS support node (SGSN), and switched packet data channels provided between the SGSN and a gateway GPRS support node (GGSN). Each PDP context usually provides a communication pathway between a particular communication device and the GGSN and, once established, can typically carry multiple flows. Each flow normally represents, for example, a particular service and/or a media component of a particular service. The PDP context therefore often represents a logical communication pathway for one or more flow across the network. To implement the PDP context between the communication device and the SGSN, radio access bearers (RAB) need to be established which commonly allow for data transfer for the communication device. The implementation of these logical and physical channels is known to those skilled in the art and is therefore not discussed further herein. The communication device UA used by an end-user for accessing the communication system may be any appropriate communication device, also called terminal. Examples may comprise user equipment UE, a mobile station MS, a cellular phone, a personal digital assistant PDA and a personal computer PC. Further examples may comprise any other equipment operable according to SIP and preferably another suitable network or transport protocol, such as the WSP, the HTTP or the TCP. A typical communication device UA may be provided with an antenna or other such transceiver and receiver device for wirelessly receiving and transmitting signals from and to a transceiver network element of a wireless communication system. A communication device may also be provided with a display and a speaker. The operation of a communication device may be controlled by means of a suitable user interface comprising control means, such as a keypad, voice commands, touch sensitive screen or pad, or combinations thereof, or the like. A communication device is typically provided with a processor and memory means as well as software and applications operating the device and enabling operation with other entities. Software, which is able to request services from other entities in a communication system, may be called a client. The session initiation protocol (SIP) is an application layer control protocol defined in document RFC 3261 “SIP: Session Initiation Protocol”, June 2002, by the Internet Engineering Task Force (IETF) for creating, modifying and terminating sessions with one or more participants. A user connected to a SIP base communication system may communicate with various entities of the communication system based on standardized SIP messages. Communication devices or user who run certain applications on the communication devices are registered with the SIP backbone so that an invitation to a particular session can be correctly delivered to these end points. SIP provides a registration mechanism for devices and users and it applies mechanisms such as location servers and registrars to route the session invitations appropriately. The details of a session, such as the type of media, codec or sampling rate, are not described in SIP headers. Rather, a body of a SIP message may contain a description of a session, encoded in an appropriate protocol format. An example of such protocol format comprises session description protocol (SDP) defined in document RFC 2327 “SDP: Session Description Protocol”, April 1998. Uniform Resource Identifiers (URI) are used to identify different types of actors in a SIP-controlled network. A URI may point to a registered user identity of an individual user, but may identify also other entities in the network, such as service provider servers or other types of resources.

Although the invention has been described in the context of particular embodiments, various modifications are possible without departing from the scope and spirit of the invention as defined by the appended claims. It should be appreciated that whilst embodiments of the present invention have mainly been described in relation to mobile communication devices such as mobile stations, embodiments of the present invention may be applicable to other types of communication devices that may access communication networks. Furthermore, embodiments may be applicable to other appropriate communication systems, even if reference has mainly been made to mobile communication systems.

Appendix A:

List of Frequently Used Abbreviations

3GPP: Third Generation Partnership Project
CSCF: Call/Session Control Function
DM: Device Management
HSS: Home Subscriber Server
HTTP: Hypertext Transfer Protocol
I-CSCF: Interrogating CSCF
IETF: Internet Engineering Task Force
IMS: IP Multimedia Subsystem
IP: Internet Protocol
OMA: Open Mobile Alliance
OTA: Over the Air (protocol)
OTA-HTTP: Push Over-the-Air Protocol, a variant of HTTP
PAP: Push Access Protocol, a variant of HTTP
PI: Push Initiator
PPG: Push Proxy Gateway
RFC: Request For Comments
S-CSCF: Serving CSCF
SIP: Session Initiation Protocol
UA: User Agent
UE: User Equipment
URI: Uniform Resource Identifier
WSP: Wireless Session Protocol
   Appendix B:
   List of Several Documents Referred to in this Application
[PushOTA]
“Push OTA Protocol Specification”, WAP Forum™, WAP-235-PushOTA, http://www.openmobilealliance.org/
[Push PAP]
“Push Access Protocol Specification”, WAP Forum™, WAP-247-PAP, http://www.openmobilealliance.org/
[PPGService]
Push Proxy Gateway Service, WAP Forum™, WAP-249-PPGService, URL:http://www.openmobilealliance.org/
[RDF]
“Resource Description Framework (RDF) Model and Syntax Specification”, World Wide Web Consortium Recommendation, O. Lassila, R. Swick, February 1999.
[UAPROF]
“WAP UAProf”. WAP Forum. WAP-248-UAProf-20010530-a. URL:http://www.openmobilealliance.org/
[3GPP2-MMS]
3GPP2 X.S0016-312 Version 1.0. MMS MM1 Stage 3 Using SIP, http://www.3gpp2.org/
[IETF-MSRP]
B. Campbel, R. Mahy, and C. Jennings. “The Message Session Relay Protocol”, draft-ietf-simple-message-sessions-10.txt, February 2005, http://www.ietf.org/internet-drafts/draft-ietf-simple-message-sessions-10.txt
[RFC3261]
J. Rosenberg, H. Shulzrinne, G. Camarillo, A. Johnston, J. Peterson, R. Sparks, M. Handley, E. Schooler. “SIP: Session Initiation Protocol”, RFC 3261, http://www.ietf.org/rfc/rfc3261.txt
[RFC3264]
J. Rosenberg, H. Shulzrinne, “An Offer/Answer model with the Session Description Protocol”, RFC 3264, http://www.ietf.org/rfc/rfc3264.txt

1. A method for performing a push operation in a communication system,
the method comprising the steps of:
receiving, at a gateway entity of the communication system, a request to perform a push operation towards a push destination entity; and
setting up a connecting session invoking a messaging session for delivering content to be pushed in the push operation towards the push destination entity.

2. The method according to claim 1, wherein said content to be pushed is received in said request to perform the push operation, the method further comprises a step of:
delivering said content to said push destination entity using said messaging session.

3. The method according to claim 1, wherein said messaging session is invoked within a context of the connecting session.

4. The method according to claim 1, wherein said messaging session is a Message Session Relay Protocol, MSRP, session and the connecting session is a Session Initiation Protocol, SIP, session.

5. The method according to claim 4, wherein said content to be pushed is encapsulated in at least one MSRP request.

6. The method according to claim 2, wherein said delivering step comprises a step of:
configuring said messaging session by setting at least one messaging session parameter to report success of the push operation.

7. The method according to claim 6, further comprising a step of:
reporting from the push destination entity towards the gateway entity, success of the push operation in a report message of the messaging session.

8. The method according to claim 7, further comprising a step of:
converting, at the gateway entity, the report message of the messaging session into a push result message for further transmission responsive to the request received in the receiving step.

9. The method according to claim 2, wherein said receiving step further comprises a step of:
analyzing the received request to perform the push operation, wherein said analyzing step comprises at least determining whether the request to perform a push operation requests a connection oriented push operation for which a report of success is required, and said delivering step is configured responsive to said analyzing step.

10. An arrangement for performing a push operation in a communication system, the arrangement comprising:
a receiver device, at a gateway entity of the communication system, configured to receive a request to perform a push operation towards a push destination entity; and
a connecting session device, at the gateway entity and the push destination entity, the connecting session device comprising setup means configured to set up a connecting session invoking a messaging session for delivering content to be pushed in the push operation towards the push destination entity.

11. The arrangement according to claim 10, wherein
said content to be pushed is received at said receiver device in said request to perform the push operation, and
the connecting session device comprises a messaging session device comprising a delivering means configured, at said gateway entity, to deliver said content to said push destination entity using said messaging session, and configured, at said push destination entity, to pickup said delivered pushed content.

12. The arrangement according to claim 11, wherein said setup means of said connecting session device is configured to invoke the messaging session in the context of the connecting session.

13. The arrangement according to claim 10, wherein said messaging session device is configured to conform to a Message Session Relay Protocol, MSRP, and the connecting session conforms to a Session Initiation Protocol, SIP, session.

14. The arrangement according to claim 13, wherein messaging session device is configured to encapsulate said content to be pushed in at least one MSRP request.

15. The arrangement according to claim 11, wherein said delivering means comprises a configuration element for configuring said messaging session by setting at least one messaging session parameter to report success of the push operation.

16. The arrangement according to claim 15, wherein said delivering means, at the push destination entity, further comprises a reporting element configured to report, from the push destination entity towards the gateway entity, success of the push operation in a report message of the messaging session, and wherein
said delivering means, at the gateway entity, is configured to pickup said report message.

17. The arrangement according to claim 16, further comprising a converter means, at the gateway entity, configured to convert the report message of the messaging session, into a push result message for further transmission.

18. The arrangement according to claim 11, wherein
said receiver device further comprises an analyzer configured to analyze the received request to perform a push operation,
wherein an analysis comprises at least whether the request to perform a push operation requests a connection oriented push operation for which a report of success is required, and
said analyzer outputs a control signal supplied to a configuration element, which is configured to configure said delivering means of the messaging session device dependent on a control signal.

19. A gateway entity for use in performing a push operation in a communication system, the gateway entity comprising:
a receiver device configured to receive a request to perform a push operation towards a push destination entity and
a connecting session device comprising setup means configured to set up a connecting session invoking a messaging session for delivering content to be pushed in the push operation towards the push destination entity.

20. The gateway entity according to claim 19, wherein
said content to be pushed is received at said receiver device in said request to perform a push operation, and
the messaging session device further comprises a delivering means configured to deliver said content to said push destination entity using said messaging session.

21. The gateway entity according to claim 19, wherein said setup means of said connecting session device is configured to invoke the messaging session in the context of a connecting session.

22. The gateway according to claim 19, wherein said messaging session device is configured to conform to a Message Session Relay Protocol, MSRP, and the connecting session conforms to a Session Initiation Protocol, SIP, session.

23. The gateway according to claim 22, wherein said messaging session device is configured to encapsulate said content to be pushed in at least one MSRP request.

24. The gateway entity according to claim 20, wherein said delivering means comprises a configuration element for configuring said messaging session by setting at least one messaging session parameter to report success of the push operation.

25. The gateway entity according to claim 19, further comprising a converter means, configured to convert a report message of the messaging session into a push result message for further transmission.

26. The gateway entity according to claim 20, wherein
said receiver device further comprises an analyzer configured to analyze the received request to perform a push operation,
wherein an analysis comprises at least whether the request to perform a push operation requests a connection oriented push operation for which a report of success is required, and
said analyzer outputs a control signal supplied to a configuration element for configuring said delivering means of the messaging session device dependent on the control signal.

27. A push destination entity for use in performing a push operation in a communication system, the push destination entity comprising:
a connecting session device comprising setup means configured to set up a connecting session invoking a messaging session for receiving content delivered in the push operation from a gateway entity of the communication system.

28. The push destination entity according to claim 27, wherein said messaging session device comprises a delivering means configured as a receiving means to pickup content pushed from a gateway entity.

29. The push destination entity according to claim 27, wherein said setup means of said connecting session device is configured to invoke the messaging session in the context of the connecting session.

30. The push destination entity according to claim 27, wherein said messaging session device is configured to conform to a Message Session Relay Protocol, MSRP, and the connecting session conforms to a Session Initiation Protocol, SIP, session.

31. The push destination entity according to claim 30, wherein said messaging session device is configured to receive pushed content encapsulated in at least one MSRP request.

32. The push destination entity according to claim 28, wherein a configuration element is configured to detect at least one set messaging session parameter set to define a request to report success of the push operation.

33. The push destination entity according to claim 32, wherein said delivering means further comprises a reporting element, responsive to said configuration element and configured to report, from the push destination entity towards the gateway entity, success of the push operation in a report message of the messaging session.

34. A computer program product embodied within a computer readable medium, the computer program product comprising software code portions for performing, when the respective software code portions are executed on a respective computer processor at a gateway entity and a push destination entity, the steps of:
receiving, at the gateway entity of the communication system, a request to perform a push operation towards the push destination entity; and
setting up a connecting session invoking a messaging session for delivering content to be pushed in the push operation towards the push destination entity.

35. A method for performing a push operation in a communication system, the method comprising the steps of:
receiving, at a gateway entity of the communication system, a request to perform a push operation towards a push destination entity; and
setting up a messaging session for delivering content to be pushed in the push operation towards the push destination entity.
